(19) United States
(12) Patent Application Publication
(10) Pub. No.: US 2026/0109337 A1
(43) Pub. Date: Apr. 23, 2026

(54) CONTROL DEVICE OF HYBRID VEHICLE, AND CONTROL METHOD OF HYBRID VEHICLE

(71) Applicant: Isuzu Motors Limited, Yokohama-shi (JP)

(72) Inventor: Sei KAMAKURA, Fujisawa-shi (JP)

(73) Assignee: Isuzu Motors Limited, Yokohama-shi (JP)

(21) Appl. No.: 19/365,225

(22) Filed: Oct. 22, 2025

(30) Foreign Application Priority Data
Oct. 23, 2024 (JP) 2024-186624

(51) Int. Cl. B60W 20/20; B60W 20/16; B60W 20/50; F01N 3/08; F01N 3/20; F01N 11/00

(52) U.S. Cl. CPC B60W 20/20; B60W 20/16; B60W 20/50; F01N 3/0814; F01N 3/0842; F01N 3/2066; F01N 11/002; B60W 2540/10; B60W 2710/0627; B60W 2710/08

(57) ABSTRACT

A control device of a hybrid vehicle having an engine and an electric motor, being capable of series hybrid driving and engine direct driving using the engine and the electric motor, and having a NOx purification system using an SCR and an LNT in an exhaust passage of the engine, the control device comprising: an abnormality detection unit that detects an abnormality in the NOx purification system related to the LNT; and a driving state control unit that, when the abnormality is detected, prohibits the engine direct driving of the vehicle and limits to the series hybrid driving, and drives the engine at an approximately constant engine output such that the engine output is equal to or greater than a predetermined value within an output range in which NOx emission from the engine does not exceed NOx purification possible amount of the NOx purification system using the SCR.

### RELATED APPLICATION(S)

This application claims the benefit of priority of Japanese Patent Application No. 2024-186624 filed on Oct. 23, 2024, the contents of which are incorporated by reference as if fully set forth herein in their entirety.

### TECHNICAL FIELD

The present disclosure relates to a control device of a hybrid vehicle and a control method of a hybrid vehicle.

### BACKGROUND ART

In recent years, hybrid vehicle configurations have become increasingly diverse due to demands for improved energy efficiency and reduced exhaust emissions (NOx).

For example, among recent hybrid vehicles, there are series/parallel hybrid composite vehicles that are capable of switching between series driving and parallel driving.

In general, series hybrid vehicles traveling on the driving force of an electric motor, and the engine is used only to generate electricity, which is then used to charge a battery or to supply electricity to the electric motor.

The series type hybrid vehicle has two driving modes: “EV driving mode” and “series driving mode”. In the EV driving mode, the hybrid vehicle travels on the driving force of the electric motor that is driven by power supply from the battery. At this time, the engine is not driven. In the “series driving mode”, the hybrid vehicle travels on the driving force of the electric motor that is driven by power supply from both the battery and the generator, or by power supply only from the generator. At this time, the engine is driven to generate electricity in the generator. The series driving mode is useful in that it allows the engine to be steadily operated near the optimum fuel consumption point.

The parallel hybrid vehicle travels on the driving force of either the electric motor or the engine, or both. In particular, a mode in which the parallel hybrid vehicle travels on the driving force of only the engine is called an “engine driving mode.” In addition, a mode in which the parallel hybrid vehicle travels on the driving force of both the engine and the electric motor is called a “parallel driving mode.” The engine driving mode and the parallel driving mode are useful in that they can suppress the occurrence of battery charge/discharge loss and various resistance losses for operating the electric motor and/or generator.

The series/parallel hybrid vehicle is a hybrid of the above two types. In other words, in this type, the drive power transmission system is switched between the series type and the parallel type by releasing or engaging (connecting and disconnecting) the clutch depending on the traveling state of the hybrid vehicle. The series/parallel hybrid vehicle is useful in that it can enjoy the advantages of both the series type hybrid vehicle and the parallel type hybrid vehicle.

In order to improve exhaust emissions (NOx) in such hybrid vehicles, it is necessary to optimize the operation of the entire vehicle, including the control of both the engine and the electric motor (see, for example, PTL 1 and PTL 2).

### Citation List

### Patent Literature

PTL 1 Japanese Patent Application Laid-Open No. 2020-050009
PTL 2 Japanese Patent Application Laid-Open No. 2019-166943

### SUMMARY OF INVENTION

### Technical Problem

Incidentally, conventionally, vehicles of this type are often equipped with a NOx purification system (hereinafter also referred to as an “LNT system”) that uses an LNT catalyst (also referred to as an absorption-type NOx catalyst) as an exhaust gas purification device for the engine.

Typically, in this type of vehicle, from the viewpoint of preventing exhaust emissions (NOx), an ECU (Electric Control Unit) having a fault diagnosis function is installed that sequentially checks whether the LNT system is functioning normally, for example, for abnormalities in the temperature of the LNT catalyst or an abnormality in the NOx sensor disposed upstream of the LNT catalyst.

Conventionally, such an ECU is configured to limit the engine output (i.e., the fuel injection amount) to suppress NOx emission from the engine when it determines that an abnormality has occurred in the LNT system.

FIG. 1 is a diagram showing an aspect of an engine-control system according to a related art when an abnormality occurs in the LNT system.

As shown in FIG. 1, limiting the engine output makes it possible to suppress the amount of NOx discharged from the engine to the outside even in a state in which NOx purification by the LNT catalyst is not performed normally. However, when the engine output is limited in this way, even if the vehicle is guaranteed to have a minimum output that allows it to drive to a repair base, when the vehicle is loaded or towed, etc., and more engine output is required to drive the vehicle compared to when the vehicle is empty, the vehicle may have difficulty driving itself in the flow of traffic.

The present invention has been made in consideration of the above problems, and the object of the present invention is to provide a control device and control method of a hybrid vehicle that makes it possible to ensure good drivability while suppressing emissions of NOx to the outside of the vehicle even if an abnormality occurs in the LNT system.

### Solution to Problem

A main aspect of the present disclosure for solving the above-mentioned problems is a control device of a hybrid vehicle having an engine and an electric motor as power sources, being capable of series hybrid driving and engine direct driving using the engine and the electric motor, and having a NOx purification system using an SCR catalyst and an LNT catalyst in an exhaust passage of the engine, the control device comprising:
an abnormality detection unit that detects an abnormality in the NOx purification system related to the LNT catalyst; and
a driving state control unit that, when the abnormality is detected, prohibits the engine direct driving as a driving mode of the vehicle and limits the driving mode to the series hybrid driving, and drives the engine at an approximately constant engine output such that the engine output is equal to or greater than a predetermined value within an output range in which NOx emission from the engine does not exceed NOx purification possible amount of the NOx purification system using the SCR catalyst.

Another aspect is a control method of a hybrid vehicle having an engine and an electric motor as power sources, being capable of series hybrid driving and engine direct driving using the engine and the electric motor, and having a NOx purification system using an SCR catalyst and an LNT catalyst in an exhaust passage of the engine, the control method comprising:
a first step of detecting an abnormality in the NOx purification system related to the LNT catalyst; and
a second step of prohibiting the engine direct driving as a driving mode of the vehicle, limiting the driving mode to the series hybrid driving, and driving the engine at an approximately constant engine output such that the engine output is equal to or greater than a predetermined value within an output range in which NOx emission from the engine does not exceed NOx purification possible amount of the NOx purification system using the SCR catalyst, the second step being performed when the abnormality is detected in the first step.

### Advantageous Effects of Invention

According to the control device of the hybrid vehicle of the present invention, even if an abnormality occurs in the LNT system, it is possible to ensure good drivability while suppressing the emission of NOx to the outside of the vehicle.

### BRIEF DESCRIPTION OF DRAWINGS

FIG. 1 is a diagram showing engine control according to a related art when an abnormality occurs in the LNT system.

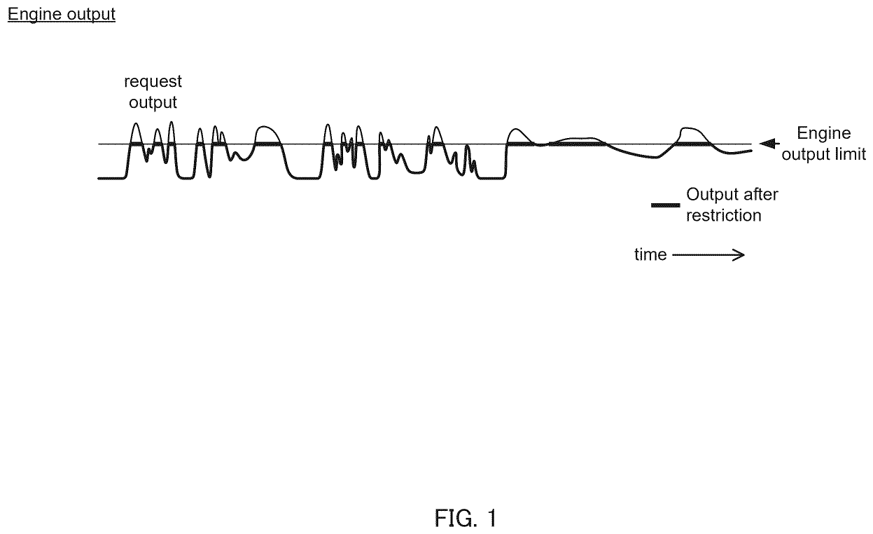

FIG. 2 is a diagram schematically showing the overall configuration of a vehicle according to one embodiment of the present invention.

FIG. 3 is a diagram showing an example of the configuration of an exhaust purification device according to one embodiment of the present invention.

FIG. 4 is a diagram showing an example of the functional configuration of an ECU according to one embodiment of the present invention.

FIG. 5 is a diagram showing engine control by the ECU according to one embodiment of the present invention when an abnormality occurs in the LNT system.

FIGS. 6A and 6B are diagrams showing examples of control maps for controlling the valve opening degree of an EGR device. FIG. 6A shows a control map used in the fuel efficiency priority mode, and FIG. 6B shows a control map used in the NOx reduction mode.

FIG. 7 is a flowchart showing an example of operation related to the LNT system abnormality detection function of the ECU according to one embodiment of the present invention.

### DESCRIPTION OF EMBODIMENTS

Hereinafter, a preferred embodiment of the present invention will be described in detail with reference to the accompanying drawings. Note that, in the present specification and drawings, components having substantially the same functions are denoted by the same reference signs, and redundant descriptions are omitted thereby.

### Overall Vehicle Configuration

Below, an example of the configuration of a hybrid vehicle (hereinafter referred to as “vehicle 1”) according to one embodiment of the present invention will be described. Vehicle 1 according to this embodiment is a series/parallel hybrid vehicle that combines the series system and the parallel system.

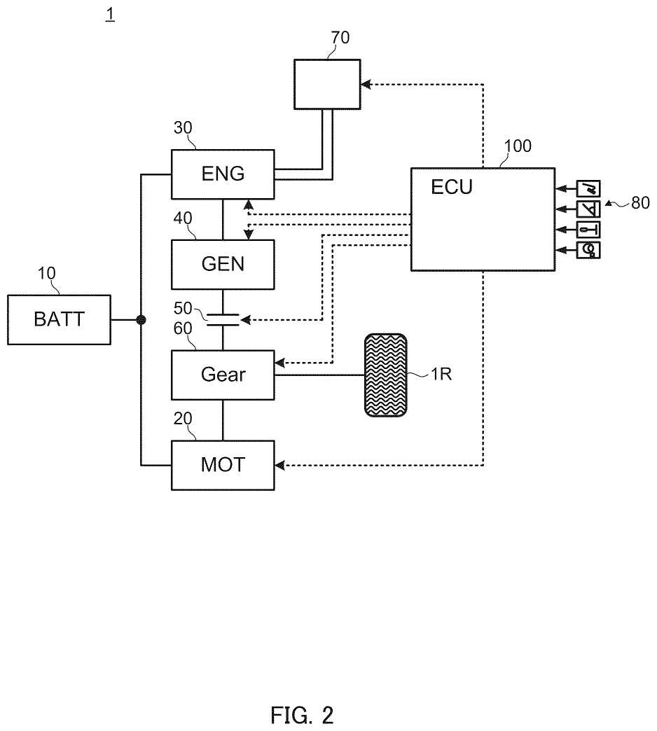

FIG. 2 is a diagram schematically showing the overall configuration of vehicle 1.

Vehicle 1 includes battery 10, electric motor 20, engine 30, generator 40, clutch 50, gear mechanism 60, exhaust purification device 70, various sensors 80 (80a-80f), and ECU 100.

Battery 10 is a lithium ion battery that supplies the electric power of a high voltage, for example, 200 to 350 V. Battery 10 is connected through wiring to electric motor 20, and is capable of supplying the electric power charged in battery 10 to electric motor 20. Battery 10 is also connected to generator 40 through wiring in parallel with electric motor 20 and is capable of charging itself with electric power generated by generator 40.

Electric motor 20 generates power for driving vehicle 1, using the electric power stored in battery 10 and/or the electric power generated by generator 40 (i.e., the electric power generated by engine 30). The output torque generated by electric motor 20 is transmitted to the driving wheels 1R of vehicle 1 via gear mechanism 60. The rotor of electric motor 20 is directly connected to gear mechanism 60. Furthermore, electric motor 20 operates as a generator during regenerative braking, and the electric power generated by electric motor 20 is charged to battery 10.

Electric motor 20 has an inverter (not shown) and converts the DC power obtained from battery 10 or the DC power sent from generator 40 (generator 40 in this embodiment converts the AC power generated by its own power generation inverter into DC power and sends it to electric motor 20 or battery 10) into AC voltage for use.

Engine 30 is directly coupled to the rotor of generator 40. When clutch 50 is disengaged and vehicle 1 is traveling in series driving mode, engine 30 is used only for generating electricity with generator 40. However, when clutch 50 is engaged, the output of engine 30 is directly transmitted to the driving wheels 1R of vehicle 1 via generator 40, clutch 50, and gear mechanism 60 as mechanical energy for vehicle 1 to travel.

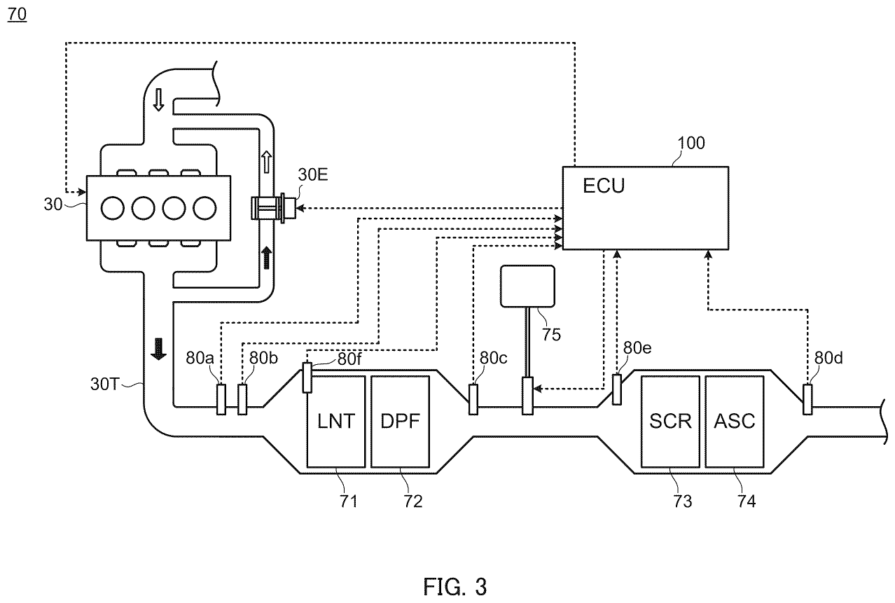

From the viewpoint of NOx emission reduction, engine 30 is provided with EGR (Exhaust Gas Recirculation) device 30E (see FIG. 3). Also, exhaust purification device 70 is disposed in exhaust passage 30T of engine 30.

Generator 40 generates electric power using the power of engine 30. The electric power generated by generator 40 is charged into battery 10 or is directly supplied to electric motor 20. Generator 40 has an inverter (not shown) and converts the AC voltage it generates into a DC voltage and sends it to battery 10 or to electric motor 20.

Clutch 50 disconnect the transmission path of the driving force from engine 30 to driving wheel 1R of vehicle 1 on the basis of an indication from ECU 100.

Gear mechanism 60 converts the driving force from engine 30 via generator 40 or the driving force from electric motor 20 into a rotation speed and output torque at a predetermined gear ratio, and transmits it to driving wheels 1R of vehicle 1.

Various sensors 80 are sensors that detect the state of each part of vehicle 1, the driving operation of the driver, etc. Various sensors 80 include, for example, a vehicle speed sensor that detects the traveling speed of vehicle 1, an accelerator opening sensor that detects the accelerator operation of the driver of vehicle 1, a rotation speed sensor that detects the rotation speed of engine 30, a rotation speed sensor that detects the rotation speed of the rotor of generator 40, a rotation speed sensor that detects the rotation speed of the rotor of electric motor 20, a voltage sensor that detects the charge state of battery 10, and sensors 80a-80f that detects the state of each part of exhaust purification device 70 (described later with reference to FIG. 3). Detection signals detected by various sensors 80 are sent to ECU 100.

ECU 100 controls the overall operation of each part of vehicle 1 by communicating with each part of vehicle 1. For example, ECU 100 performs switching of the transmission system of the driving force to the driving wheels 1R, control related to connection and disconnection of clutch 50, operation control of engine 30, operation control of generator 40, operation control of electric motor 20, charge and discharge control of battery 10, operation control of exhaust purification device 70, and the like.

Furthermore, ECU 100 acquires sensor information from various sensors 80 provided in vehicle 1 and detects the state of each part of vehicle 1.

ECU 100 includes, for example, a central processing unit (CPU), a read only memory (ROM), a random access memory (RAM), an input port, and an output port. Each function of ECU 100 is realized, for example, by the CPU referring to a control program and various data stored in the ROM, the RAM, etc. However, some or all of the functions may be realized by processing by a digital signal processor (DSP) or a dedicated hardware circuit (for example, an ASIC or an FPGA) instead of or in addition to processing by the CPU.

Vehicle 1 has, for example, the following driving modes: (a) an EV driving mode, (b) a series driving mode, (c) an engine driving mode, and (d) a parallel driving mode.

In the EV driving mode, clutch 50 is disengaged and engine 30 is stopped. Vehicle 1 travels using the driving force of electric motor 20 which is driven by the power supply from battery 10.

In the series driving mode, clutch 50 is released and engine 30 is operated to supply electric power that enables electric motor 20 to output a required driving force based on the accelerator opening, the vehicle speed, etc. Vehicle 1 travels by the driving force of electric motor 20 that is driven by the electric power supplied from generator 40. In addition, at this time, auxiliary electric power from battery 10 may be supplied to electric motor 20.

In the engine driving mode, clutch 50 is engaged, and vehicle 1 travels only by the driving force of engine 30. When traveling in the engine driving mode, the rotor of electric motor 20 and the rotor of generator 40 are rotated together with the crankshaft of engine 30.

In the parallel driving mode, clutch 50 is engaged, and vehicle 1 travels using the driving forces of both engine 30 and electric motor 20. When traveling in the parallel driving mode, the rotor of generator 40 is rotated together with the crankshaft of engine 30.

ECU 100 switches between these driving modes so as to optimize, for example, energy efficiency (for example, fuel economy). This control scheme is a conventionally known technique, and therefore will not be described here.

In the following, driving in the engine driving mode and the parallel driving mode will also be referred to as “engine direct driving”, and driving in the series driving mode will also be referred to as “series hybrid driving”.

### Configuration of Exhaust Purification Device 70

FIG. 3 is a diagram showing an example of the configuration of exhaust purification device 70.

Exhaust purification device 70 includes LNT catalyst 71, PM filter 72, SCR catalyst 73, ASC catalyst 74, and urea water supply device 75. Here, these catalysts or the like are disposed in exhaust passage 30T of engine 30, from the upstream side toward the downstream side, in the order of LNT catalyst 71, PM filter 72, SCR catalyst 73 and ASC catalyst 74.

LNT catalyst 71, when there is an excess of oxygen in the exhaust gas, absorbs NOx in the exhaust gas and, in a reducing atmosphere, causes the absorbed NOx to react with hydrocarbons and the like in the exhaust gas, to reduce it to harmless gas such as nitrogen and to release it. LNT catalyst 71 may be, for example, a catalyst carrier such as alumina, which supports a catalyst for reducing NOx, such as platinum or rhodium, and a NOx absorption material, such as calcium or barium.

Incidentally, the efficiency with which LNT catalyst 71 can store NOx decreases as LNT catalyst 71 approaches a saturated state. Therefore, the state of storage of NOx in LNT catalyst 71 is monitored by ECU 100. That is, when the storage of NOx in LNT catalyst 71 progresses and approaches a saturated state, ECU 100 operates engine 30 at a rich air-fuel ratio (called a rich spike), thereby forcibly generating exhaust gas with a reducing atmosphere and purging LNT catalyst 71 of NOx.

PM filter 72 captures particulate matter (PM) contained in the exhaust gas and is made of porous ceramic such as cordierite or silicon carbide.

SCR catalyst 73 (also referred to as a NOx selective reduction catalyst) adsorbs ammonia hydrolyzed by the urea water supplied from urea water supply device 75, and selectively reduces and purifies NOx from the exhaust gas by the adsorbed ammonia. As SCR catalyst 73, for example, a catalyst in which a NOx reduction catalyst such as Fe zeolite, Cu zeolite, or vanadium is supported on the surface of a ceramic support can be used.

ASC catalyst 74 (also referred to as an ammonia slip suppression catalyst) suppresses the ammonia leaking from SCR catalyst 73 from being discharged to the outside. ASC catalyst 74 oxidizes the ammonia that has passed through SCR catalyst 73 and decomposes it into water and nitrogen, thereby suppressing the ammonia slip from SCR catalyst 73.

Urea water supply device 75 injects urea water upstream of SCR catalyst 73 in exhaust passage 30T. Urea water supply device 75 includes, for example, a urea water addition valve, a urea water tank, and a supply pump. That is, in urea water supply device 75, urea water pressure-fed from the urea water tank by the supply pump is injected from the urea water addition valve into exhaust passage 30T.

The amount of urea water injected from urea water supply device 75 into exhaust passage 30T is controlled by adjusting the opening of the urea water addition valve. The opening of the urea water addition valve is controlled by a control signal output from ECU 100.

The control of urea water injection by ECU 100 is the same as the conventionally known technique, and therefore description thereof will be omitted here. ECU 100 sets the target value of the ammonia storage amount in SCR catalyst 73 based on, for example, the catalyst temperature of SCR catalyst 73 indicated by first temperature sensor 80e. ECU 100 then sequentially calculates the ammonia consumption amount in SCR catalyst 73 based on, for example, sensor values indicated by second NOx sensor 80c and flow rate sensor 80a (i.e., the amount of NOx flowing into SCR catalyst 73). ECU 100 then controls the amount of urea water injection from urea water supply device 75 so that the ammonia storage amount in SCR catalyst 73 is maintained at the target value.

In this manner, in exhaust purification device 70 according to this embodiment, both SCR catalyst 73 and LNT catalyst 71 are used in order to minimize exhaust emissions (NOx).

In general, SCR catalyst 73 has high NOx purification performance, but is inactive when the exhaust temperature is low (e.g., below 200° C.). In this regard, by providing both SCR catalyst 73 and LNT catalyst 71 in exhaust passage 30T, it becomes possible to purify the NOx emitted from engine 30 by LNT catalyst 71 when the exhaust temperature is low and SCR catalyst 73 is inactive, such as during engine start-up.

In addition, with this configuration, even if an abnormality occurs in the NOx purification system using LNT catalyst 71, it is possible to purify NOx using SCR catalyst 73.

Exhaust purification device 70 is provided with various sensors 80, such as a flow sensor 80a that detects the flow rate of intake air flowing into engine 30, a first NOx sensor 80b that detects the amount of NOx exhausted from engine 30, a second NOx sensor 80c that detects the amount of NOx flowing into SCR catalyst 73, a third NOx sensor 80d that detects the amount of NOx flowing out from vehicle 1 to the outside, a first temperature sensor 80e that detects the temperature of SCR catalyst 73, and a second temperature sensor 80f that detects the temperature of LNT catalyst 71. These various sensors 80 sequentially transmit sensor information obtained by detection to ECU 100.

### Detailed Configuration of ECU 100

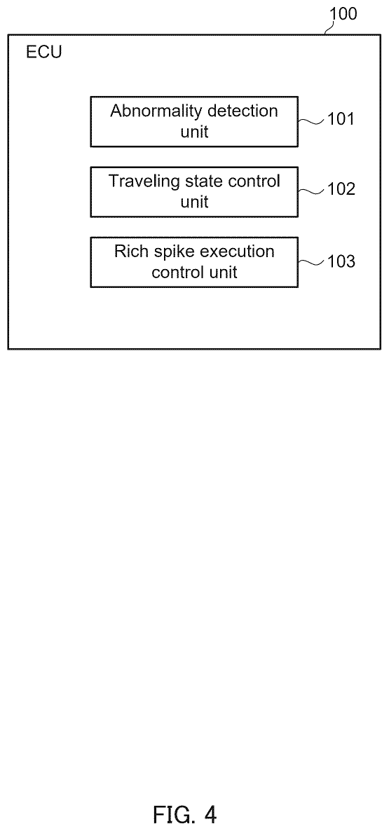

FIG. 4 is a diagram showing an example of the functional configuration of the ECU.

ECU 100 has the functions of abnormality detection unit 101, traveling state control unit 102, and rich spike execution control unit 103.

### Abnormality Detection Unit 101

Abnormality detection unit 101 detects abnormalities related to the NOx purification system (hereinafter, LNT system) that uses LNT catalyst 71 disposed in exhaust passage 30T of engine 30.

Here, an abnormality related to the LNT system is an abnormality that leads to a state in which LNT catalyst 71 is unable to sufficiently purify NOx in the exhaust gas (i.e., a failure mode in which it is determined that the purification performance of LNT catalyst 71 cannot be ensured).

Such abnormal situations include, for example, an abnormal temperature of LNT catalyst 71, an abnormal sensor value or an abnormal operation of first NOx sensor 80b disposed upstream of LNT catalyst 71, and the like.

The temperature abnormality of LNT catalyst 71 is, for example, a state in which a temperature drop of LNT catalyst 71 occurs due to the influence of condensed water from engine 30 or upstream piping. Under such circumstances, the NOx purification performance of LNT catalyst 71 is in a deteriorated state. Also, under a situation in which an abnormality occurs in first NOx sensor 80b disposed upstream of LNT catalyst 71, the amount of NOx stored in LNT catalyst 71 cannot be accurately grasped. Therefore, under such circumstances, rich spike execution control unit 103 described below stops the execution of the rich spike. In other words, under such circumstances, LNT catalyst 71 may be in a saturated state, and NOx purification performance of LNT catalyst 71 may be deteriorated.

Abnormality detection unit 101 can detect the temperature abnormality of LNT catalyst 71 based on, for example, the sensor value indicated by second temperature sensor 80f. Furthermore, abnormality detection unit 101 determines that an abnormality has occurred in first NOx sensor 80b when, for example, the sensor value of first NOx sensor 80b indicates an abnormal value or the detection signal of first NOx sensor 80b is interrupted. When abnormality detection unit 101 detects such an abnormality related to the LNT system, it sets an abnormality occurrence flag in a storage unit (for example, RAM) in order to switch the operating state of vehicle 1.

Incidentally, an oxygen concentration sensor (not shown) may be disposed in exhaust passage 30T upstream of LNT catalyst 71. If an abnormality occurs in such an oxygen concentration sensor, there is a risk that the purification performance of LNT catalyst 71 may not be ensured. Therefore, even if an abnormality occurs in the oxygen concentration sensor, abnormality detection unit 101 may set the abnormality occurrence flag.

Abnormality detection unit 101 may also set the abnormality occurrence flag when an abnormality occurs in flow rate sensor 80a, etc. This is because the amount of NOx stored in LNT catalyst 71 becomes uncertain in such a case as well.

### Driving State Control Unit 102

Driving state control unit 102 controls the driving mode of vehicle 1.

As described above, under normal circumstances (meaning when the LNT system is normal state; the same applies below), driving state control unit 102 switches the driving mode of vehicle 1 between the EV driving mode, the series driving mode, the engine driving mode, and the parallel driving mode so as to maximize the energy efficiency.

However, when an abnormality in the LNT system is detected by abnormality detection unit 101, driving state control unit 102 prohibits the direct engine driving as the driving mode of vehicle 1 and limits the driving mode to the series hybrid driving. Then, in this series hybrid driving, driving state control unit 102 drives the engine at an approximately constant engine output such that the engine output is equal to or greater than a predetermined value within an output range in which NOx emission from engine 30 does not exceed NOx purification possible amount of the NOx purification system using SCR catalyst 73.

This point will be described in detail below.

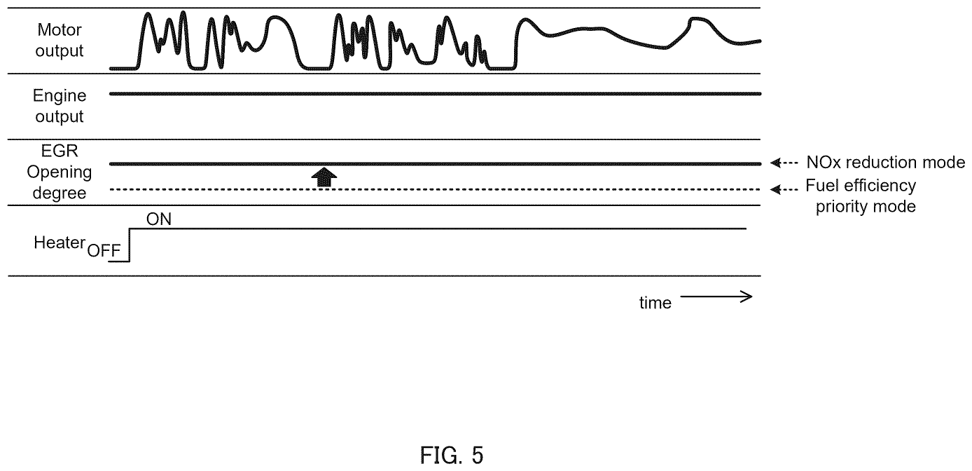

FIG. 5 is a diagram showing the manner in which ECU 100 controls engine 30 when the abnormality occurs in the LNT system.

As described above, in engine control according to the related art, when the abnormality occurs in the LNT system, the output (i.e. fuel injection amount) of engine 30 is limited from the viewpoint of suppressing the amount of NOx emitted to the outside from engine 30. However, in this case, when the engine output is required for traveling compared to an empty state, such as when the vehicle is loaded or towed, it may become difficult for the vehicle to travel under its own power in the traffic flow.

In this regard, driving state control unit 102 according to this embodiment limits the driving mode of vehicle 1 to series hybrid driving, and drives engine 30 at an approximately constant engine output (i.e. steady-state operation) such that the engine output is equal to or greater than a predetermined value within an output range in which NOx emission from engine 30 does not exceed NOx purification possible amount of the NOx purification system using SCR catalyst 73.

Incidentally, the engine output at this time is preferably close to the maximum value within the above output range, but is more preferably set to a value within the above output range that ensures a predetermined margin from the maximum value, for example, taking into consideration changes over time in the purification performance of SCR catalyst 73. Also, the engine output at this time may not be a completely constant value during the steady-state operation, and may be changed gradually in accordance with fluctuations in the required driving force from time to time.

Thus, even when the abnormality occurs in the LNT system, it is possible to ensure the necessary driving force for vehicle 1 without limiting the output, and good drivability can be maintained.

At this time, the output of electric motor 20 satisfies the required driving force required for vehicle 1 to travel, and engine 30 performs a power generating operation. The required driving force required for vehicle 1 to travel is set, for example, based on the travel speed of vehicle 1 and the accelerator operation (i.e., accelerator opening) of the driver, and electric motor 20 is controlled so as to output the required driving force. At this time, the electric power required for driving electric motor 20 is directly supplied from engine 30 (i.e., generator 40), and the shortage of the generated power of engine 30 (i.e., generator 40) is replenished from battery 10. Moreover, the surplus generated power of engine 30 (i.e., generator 40) is charged to battery 10.

In general, during engine direct driving(i.e., engine driving mode or parallel driving mode), the operating state of engine 30 needs to be changed in response to an acceleration request from vehicle 1, which tends to increase instantaneous NOx emission and also increases the NOx emission discharged outside vehicle 1. In this regard, as described above, during the steady-state operation of engine 30 using series hybrid driving, there are fewer fluctuations in the exhaust temperature, flow rate, and NOx emission, making it possible to suppress instantaneous NOx emission due to sudden acceleration or the like.

In addition, in vehicle 1 according to this embodiment, in principle, all of the NOx emitted from engine 30 is purified by SCR catalyst 73, so that even if LNT catalyst 71 is not functioning completely, the amount of NOx emitted to the outside from vehicle 1 can be kept to an extremely small amount.

Here, the “output range of engine 30 during the steady-state operation” (i.e., output range in which NOx emission from engine 30 does not exceed NOx purification possible amount of the NOx purification system using SCR catalyst 73) may be set to a range that has been determined in advance by experiments or simulations, for example, taking into account the NOx purification performance expected under normal state of SCR catalyst 73.

However, the NOx purification performance of SCR catalyst 73 varies greatly depending on the situation at the time. Therefore, it is desirable to set the “output range of engine 30 during the steady-state operation” to a more accurate range taking into account the current situation. By doing so, the steady-state operation of engine 30 can be performed with the output of engine 30 set as large as possible. Specifically, the current NOx purification possible amount of SCR catalyst 73 can be calculated based on, for example, the current temperature of SCR catalyst 73 and the ammonia storage amount of SCR catalyst 73. Then, from this NOx purification possible amount, it is possible to accurately calculate the output range of engine 30 in which the NOx emission from engine 30 does not exceed the NOx purification possible amount by using a preset control map (for example, a map in which the correspondence relationship between the NOx purification possible amount and the maximum engine output value is specified by experiments or simulations).

Here, when the abnormality occurs in the LNT system, it is desirable for driving state control unit 102 to operate engine 30 in the NOx reduction mode rather than in the fuel efficiency priority mode. That is, in the fuel efficiency priority mode, the operating state of engine 30 (e.g., engine speed, output torque, fuel injection timing, EGR rate, boost pressure of the turbocharger, etc.) is generally set from the viewpoint of improving fuel efficiency, but this fuel efficiency priority mode is not necessarily preferable from the viewpoint of reducing NOx emission.

From this viewpoint, in the NOx reduction mode, driving state control unit 102 increases the valve opening of the EGR device 30E, for example, to a value larger than the valve opening set in the fuel efficiency priority mode, thereby reducing the amount of NOx emission from engine 30.

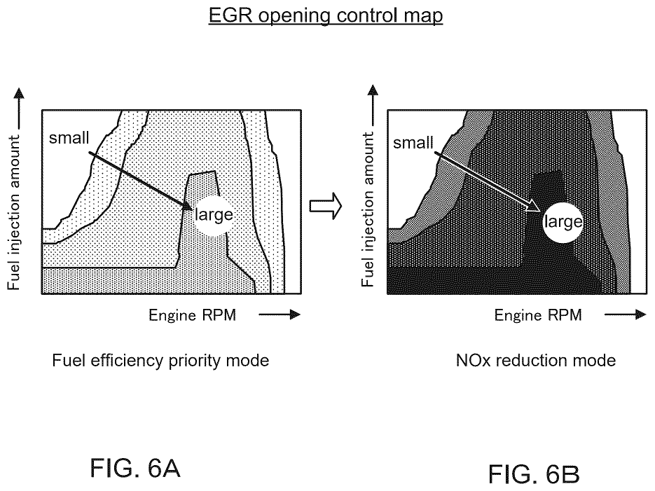

FIGS. 6A and 6B is diagrams showing examples of control maps for controlling the valve opening degree of the EGR device 30E. FIG. 6A shows a control map used in the fuel efficiency priority mode, and FIG. 6B shows a control map used in the NOx reduction mode.

In the control map of EGR device 30E, the valve opening is set for each engine speed and fuel injection amount. In FIG. 6A and FIG. 6B, “large” and “small” represent the valve opening of EGR device 30E to be set. In FIG. 6A and FIG. 6B, the darker the color, the larger the valve opening.

Generally, when the combustion gas temperature becomes high, the amount of NOx, an environmental pollutant, generated increases rapidly. EGR device 30E recirculates the exhaust gas into the intake manifold, lowers the oxygen concentration of the intake air, and slows the combustion speed, thereby lowering the combustion temperature and reducing the amount of NOx generated. The valve opening of EGR device 30E affects not only the amount of NOx generated, but also the output torque of engine 30, the generation of white smoke, and fuel efficiency. Therefore, the control map of EGR device 30E is set with an optimal EGR valve opening (i.e., an optimal amount of EGR introduction) corresponding to the engine operating state, which is derived in advance by testing or the like.

In the control map used in the NOx reduction mode, the valve opening is set larger in each operating state of engine 30 compared to the control map used in the fuel efficiency priority mode.

That is, in the NOx reduction mode, the valve opening of the EGR device 30E is made larger than in the normal operation (i.e., the fuel efficiency priority mode), and the EGR rate is increased. This reduces the amount of NOx discharged from engine 30.

In the NOx reduction mode, further, the boost pressure of the turbocharger (not shown) connected to engine 30 may be reduced, or the fuel injection timing may be controlled to be retarded. This makes it possible to further reduce NOx emission from engine 30.

In other words, when vehicle 1 is driven in series hybrid driving, in the fuel economy priority mode, engine 30 is controlled to operate at an operating point close to the most efficient operating point. In contrast, in the NOx reduction mode, the control of engine 30 is changed as described above, and engine 30 is controlled to operate at an operating point that is different from the most efficient operating point. Therefore, in the NOx reduction mode, the fuel economy itself is lower than in the fuel economy priority mode.

In addition, in the NOx reduction mode, when the temperature of SCR catalyst 73 is low, ECU 100 preferably uses an electric heater (not shown) for heating SCR catalyst 73 to increase the temperature of SCR catalyst 73. This is because in the NOx reduction mode, the valve opening of the EGR device 30E is increased to lower the combustion temperature in engine 30, which reduces the exhaust temperature and may prevent SCR catalyst 73 from rising to a temperature at which it can efficiently purify NOx. However, there are cases in which the exhaust temperature does not decrease even if the combustion temperature decreases, so it is preferable to control ON/OFF of the electric heater according to the detected temperature of SCR catalyst 73.

### Rich Spike Execution Control Unit 103

Rich spike execution control unit 103 executes a rich spike in engine 30 based on the amount of NOx stored in LNT catalyst 71.

The control of the rich spike execution timing by rich spike execution control unit 103 is the same as the conventionally known method and therefore a detailed description will be omitted here. Rich spike execution control unit 103 calculates the amount of occluded NOx per unit time based on sensor information from flow rate sensor 80a and first NOx sensor 80b, or based on the estimated NOx emission amount from engine 30 and a model within ECU 100, and estimates the amount of occluded NOx in LNT catalyst 71 at each point in time during driving by integrating the amount of occluded NOx per unit time. Then, when the amount of occluded NOx in LNT catalyst 71 exceeds a predetermined value (e.g., 80%), rich spike execution control unit 103 causes engine 30 to execute a rich spike.

Rich spike execution control unit 103 may stop the execution of the rich spike when the abnormality is detected in the LNT system.

### Operation Flow of ECU 100

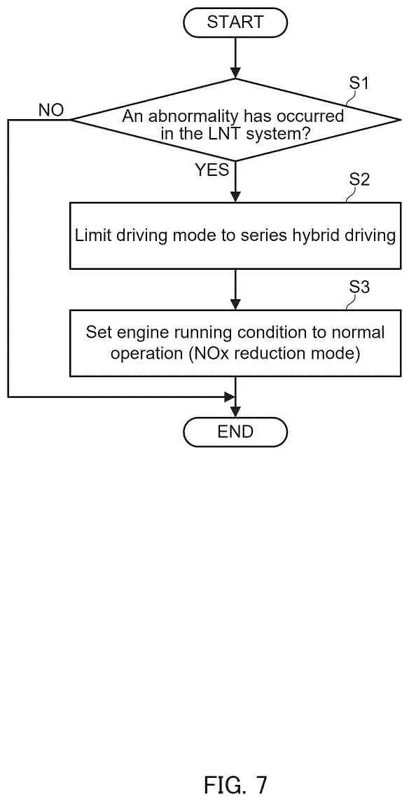

FIG. 7 is a flowchart showing an example of the operation of the LNT system abnormality detection function of ECU 100.

In step S1, ECU 100 determines whether or not an abnormality has occurred in the LNT system. If an abnormality has occurred in the LNT system (S1: YES), ECU 100 proceeds to step S2. If an abnormality has not occurred in the LNT system (S1: NO), ECU 100 ends the process of the flowchart in FIG. 7 without performing any particular process.

In step S2, ECU 100 prohibits the engine direct driving and limits the driving mode to the series hybrid driving as the driving mode of vehicle 1. That is, if vehicle 1 is currently in engine direct driving, ECU 100 switches the driving mode to the series hybrid driving.

In step S3, ECU 100 sets the driving state of engine 30 to the steady-state operation in the NOx reduction mode. At this time, ECU 100 drive engine 30 at an approximately constant engine output such that the engine output is equal to or greater than a predetermined value within an output range in which NOx emission from engine 30 does not exceed NOx purification possible amount of the NOx purification system using SCR catalyst 73.

At this time, ECU 100 calculates the NOx purification possible amount of SCR catalyst 73 (i.e., amount of NOx that can be purified by SCR catalyst 73) based on, for example, the current temperature of SCR catalyst 73 and the amount of ammonia stored in SCR catalyst 73. Then, ECU 100 calculates the output range of engine 30 during the steady-state operation (i.e., the output range in which the amount of NOx emitted from engine 30 does not exceed the NOx purification possible amount of SCR catalyst 73) based on the calculated NOx purification possible amount of SCR catalyst 73 and the preset control map.

Further, at this time, ECU 100 sets the operating state of engine 30 to the NOx reduction mode. That is, ECU 100 performs control such as increasing the valve opening of EGR device 30E, lowering the boost pressure of the turbocharger connected to engine 30, and retarding the fuel injection timing.

By executing the above-described processing, ECU 100 enables vehicle 1 to travel with the necessary driving force for vehicle 1, while suppressing the amount of NOx emitted to the outside from vehicle 1, even if the abnormality occurs in the LNT system.

### Effect

As described above, in this embodiment, a control device of a hybrid vehicle is disclosed, the hybrid vehicle having an engine and an electric motor as power sources, being capable of series hybrid driving and engine direct driving using the engine and the electric motor, and having a NOx purification system using an SCR catalyst and an LNT catalyst in an exhaust passage of the engine, the control device comprising:
an abnormality detection unit that detects an abnormality in the NOx purification system related to the LNT catalyst; and
a driving state control unit that, when the abnormality is detected, prohibits the engine direct driving as a driving mode of the vehicle and limits the driving mode to the series hybrid driving, and drives the engine at an approximately constant engine output such that the engine output is equal to or greater than a predetermined value within an output range in which NOx emission from the engine does not exceed NOx purification possible amount of the NOx purification system using the SCR catalyst.

According to the control device of this embodiment, even if an abnormality occurs in the LNT system, it is possible to ensure the necessary driving force for the vehicle while suppressing the emission of NOx outside the vehicle, thereby maintaining good drivability.

Although specific examples of the present invention have been described in detail above, these are merely examples and do not limit the scope of claims. The technology described in the scope of claims includes various modifications and changes of the specific examples exemplified above.

For example, the layout of the hybrid vehicle 1 to which the control device of the present invention is applied may be modified in various ways other than the manner shown in FIG. 2. Specifically, the layout of the hybrid vehicle 1 may be a layout in which generator 40 and the axle are not coaxial (e.g., a layout in which generator 40 is driven by a belt), a layout in which electric motor 20 is disposed between engine 30 and gear mechanism 60, or the like.

In addition, various modifications are possible for the various sensors 80 provided in the hybrid vehicle 1 to which the control device of the present invention is applied. For example, first NOx sensor 80b does not necessarily have to be provided. In this case, ECU 100 may estimate the amount of NOx emission from engine 30 based on, for example, the operating state of engine 30 and the valve opening of EGR device 30E.

This application is entitled to (or claims) the benefit of Japanese Patent Application No. 2024-186624, filed Oct. 23, 2024, the disclosure of which including the specification, drawings and abstract is incorporated herein by reference in its entirety.

### Industrial Applicability

According to the control device of the hybrid vehicle of the present invention, even if an abnormality occurs in the LNT system, it is possible to ensure good drivability while suppressing the emission of NOx to the outside of the vehicle.

### Reference Signs List

1 Vehicle
1R Driving wheel
10 Battery
20 Electric motor
30 Engine
30E EGR device
40 Generator
50 Clutch
60 Gear mechanism
70 Exhaust purification device
71 LNT catalyst
72 PM filter
73 SCR catalyst
74 ASC catalyst
75 Urea water supply device
80a Flow sensor
80b First NOx sensor
80c Second NOx sensor
80d Third NOx sensor
80e First temperature sensor
80f Second temperature sensor
100 ECU
101 Abnormality detection unit
102 Driving state control unit
103 Rich spike execution control unit

1. A control device of a hybrid vehicle having an engine and an electric motor as power sources, being capable of series hybrid driving and engine direct driving using the engine and the electric motor, and having a NOx purification system using an SCR catalyst and an LNT catalyst in an exhaust passage of the engine, the control device comprising:
an abnormality detection unit that detects an abnormality in the NOx purification system related to the LNT catalyst; and
a driving state control unit that, when the abnormality is detected, prohibits the engine direct driving as a driving mode of the vehicle and limits the driving mode to the series hybrid driving, and drives the engine at an approximately constant engine output such that the engine output is equal to or greater than a predetermined value within an output range in which NOx emission from the engine does not exceed NOx purification possible amount of the NOx purification system using the SCR catalyst.

2. The control device of the hybrid vehicle according to claim 1, wherein the driving state control unit, when the abnormality is detected, operates the engine in a NOx reduction mode instead of a fuel efficiency priority mode.

3. The control device of the hybrid vehicle according to claim 2, wherein in the NOx reduction mode, an opening of an EGR valve of the engine is increased to a value greater than the opening set in the fuel efficiency priority mode.

4. The control device of the hybrid vehicle according to claim 1, wherein the NOx purification possible amount of the SCR catalyst is calculated based on temperature of the SCR catalyst and ammonia storage amount of the SCR catalyst at the time when the abnormality is detected.

5. The control device of the hybrid vehicle according to claim 1, wherein the driving state control unit, when the abnormality is detected, drive the engine at the approximately constant engine output such that the engine output is at a maximum output within the output range or an output that is a margin greater than the maximum output.

6. The control device of the hybrid vehicle according to claim 1, wherein, when the abnormality is detected, an output of the engine is used by the electric motor, and a required driving force according to an accelerator operation by a driver is satisfied using the output of the electric motor.

7. The control device of the hybrid vehicle according to claim 1, wherein the abnormality is a failure mode in which it is determined that the purification performance of the LNT catalyst cannot be ensured.

8. The control device of the hybrid vehicle according to claim 7, wherein the abnormality includes a temperature abnormality of the LNT catalyst, and an abnormal sensor value and an abnormal operation of a NOx sensor disposed upstream of the LNT catalyst.

9. A control method of a hybrid vehicle having an engine and an electric motor as power sources, being capable of series hybrid driving and engine direct driving using the engine and the electric motor, and having a NOx purification system using an SCR catalyst and an LNT catalyst in an exhaust passage of the engine, the control method comprising:
a first step of detecting an abnormality in the NOx purification system related to the LNT catalyst; and
a second step of prohibiting the engine direct driving as a driving mode of the vehicle, limiting the driving mode to the series hybrid driving, and driving the engine at an approximately constant engine output such that the engine output is equal to or greater than a predetermined value within an output range in which NOx emission from the engine does not exceed NOx purification possible amount of the NOx purification system using the SCR catalyst, the second step being performed when the abnormality is detected in the first step.
